(19) United States
(12) Patent Application Publication
(10) Pub. No.: US 2023/0317966 A1
(43) Pub. Date: Oct. 5, 2023

(54) POROUS CURRENT COLLECTORS FOR NEGATIVE ELECTRODES AND ELECTROCHEMICAL CELLS INCLUDING THE SAME

(71) Applicant: GM GLOBAL TECHNOLOGY OPERATIONS LLC, Detroit, MI (US)

(72) Inventors: Zhe LI, Shanghai (CN); Qi LU, Shanghai (CN); Yong LU, Shanghai (CN); Meiyuan WU, Shanghai (CN); Qili SU, Shanghai (CN); Haijing LIU, Shanghai (CN)

(73) Assignee: GM GLOBAL TECHNOLOGY OPERATIONS LLC, Detroit, MI (US)

(21) Appl. No.: 17/853,690

(22) Filed: Jun. 29, 2022

(30) Foreign Application Priority Data
Mar. 31, 2022 (CN) 202210340306.6

(51) Int. Cl. H01M 4/76; H01M 10/0525; H01M 10/0562; H01M 10/44; H01M 4/62; H01M 4/134

(52) U.S. Cl. CPC H01M 4/762; H01M 10/0525; H01M 10/0562; H01M 2004/027; H01M 4/626; H01M 4/625; H01M 4/134; H01M 10/44

(57) ABSTRACT

An electrochemical cell that cycles lithium ions includes a positive electrode, a negative electrode current collector spaced apart from the positive electrode, and an ionically conductive electrolyte disposed between the positive electrode and the negative electrode current collector. The negative electrode current collector is of unitary one-piece construction and has a three-dimensional porous structure that defines an interconnected network of open pores. During charging of the electrochemical cell, lithium metal is deposited within the open pores of the negative electrode current collector.

### CROSS-REFERENCE TO RELATED APPLICATIONS

This application claims the benefit and priority of Chinese Application No. 202210340306.6, filed Mar. 31, 2022. The entire disclosure of the above application is incorporated herein by reference.

### INTRODUCTION

This section provides background information related to the present disclosure which is not necessarily prior art.

The present disclosure relates to electrochemical cells that cycle lithium ions and, more particularly, to anode-free electrochemical cells having three-dimensional porous negative electrode current collectors.

A battery is a device that converts chemical energy into electrical energy by means of electrochemical reduction-oxidation (redox) reactions. In secondary or rechargeable batteries, these electrochemical reactions are reversible, which allows the batteries to undergo multiple charging and discharge cycles.

Secondary lithium batteries generally comprise one or more electrochemical cells that include a negative electrode, a positive electrode, and an electrolyte, with the negative and positive electrodes oftentimes disposed on respective negative and positive electrode current collectors. Such batteries are powered by the cooperative movement of lithium ions and electrons between the negative and positive electrodes of the electrochemical cells. The electrolyte is ionically conductive and provides a medium for the conduction of the lithium ions through the electrochemical cell between the negative and positive electrodes. The current collectors are electrically conductive and allow the electrons to simultaneously travel from one electrode to another via an external circuit. A separator may be sandwiched between the negative and positive electrodes to physically separate and electrically insulate the electrodes from each other while permitting free ion flow therebetween.

Lithium metal is a desirable negative electrode material for secondary lithium batteries due to its high gravimetric and volumetric specific capacities (3,860 mAh/g and 2061 mAh/cm³, respectively) and its relatively low reduction potential (−3.04 V versus standard hydrogen electrode). Secondary lithium metal batteries may be assembled using an anode-free configuration wherein, during charging of the electrochemical cells, lithium metal is electrochemically deposited directly on a planar facing surface of a bare negative electrode current collector, without the use of a host material for insertion or storage of the lithium ions. The absence of a lithium-ion host material at the negative electrode side of the electrochemical cell reduces the weight and the thickness of the cell, thereby increasing the energy density thereof. However, in some instances, the lithium metal deposited on surface of a negative electrode current collector may exhibit a mossy or dendritic structure, which may reduce the cycling efficiency of the electrochemical cell. In addition, due to the low reduction potential of lithium metal, undesirable side reactions may occur at an interface between the lithium metal negative electrode and the electrolyte, which may result in decomposition of the electrolyte and the consumption of active lithium. The large volumetric changes experienced by lithium metal negative electrodes during repeated cycling of secondary lithium metal batteries may exacerbate the above scenarios.

### SUMMARY

This section provides a general summary of the disclosure and is not a comprehensive disclosure of its full scope or all of its features.

The present disclosure relates to an electrochemical cell that cycles lithium ions. The electrochemical cell comprises a positive electrode, a negative electrode current collector spaced apart from the positive electrode, and an ionically conductive electrolyte disposed between the positive electrode and the negative electrode current collector. The negative electrode current collector is of unitary one-piece construction and has a three-dimensional porous structure that defines an interconnected network of open pores. During charging of the electrochemical cell, lithium metal is deposited within the open pores of the negative electrode current collector.

The negative electrode current collector may have a thickness defined between a front side and an opposite back side thereof and a width defined between a first end and an opposite second end thereof. The thickness and the width of the negative electrode current collector may be substantially perpendicular to one another. The interconnected network of open pores may be defined by walls having wall surfaces that extend between the front side and the back side and between the first end and the second end of the negative electrode current collector.

During charging of the electrochemical cell, lithium metal may be plated onto the walls surfaces that extend between the front side and the back side and between the first end and the second end of the negative electrode current collector.

The thickness of the negative electrode current collector may be greater than or equal to about 1 micrometer to less than or equal to about 4 millimeters.

The walls of the negative electrode current collector may be made of an electrochemically inactive electrically conductive material. The electrochemically inactive electrically conductive material may comprise a nickel-based material, an iron-based material, a titanium-based material, a copper-based material, a tin-based material, or a combination thereof.

The wall surfaces of the walls of the negative electrode current collector may be coated with a layer of an electrochemically inactive carbon-based material.

The negative electrode current collector may have a porosity of greater than or equal to about 0.5 to less than or equal to about 0.99.

The electrochemical cell may comprise a lithium metal negative electrode. The lithium metal negative electrode may comprise, by weight, greater than 97% lithium. The lithium metal negative electrode may be formed within the open pores of the negative electrode current collector by the electrochemical deposition of lithium metal within the open pores of the negative electrode current collector during charging of the electrochemical cell. The lithium metal may be deposited substantially entirely within the open pores of the negative electrode current collector.

In aspects, the interconnected network of open pores may be defined by a three-dimensional stochastic support structure.

In some aspects, the interconnected network of open pores may be defined by a three-dimensional periodic lattice support structure including a plurality of repeating unit cells.

The ionically conductive electrolyte may comprise solid electrolyte material particles. The solid electrolyte material particles may comprise a metal oxide-based material, a sulfide-based material, a nitride-based material, a hydride-based material, a halide-based material, a borate-based material, or a combination thereof.

An electrochemical cell that cycles lithium ions is disclosed. The electrochemical cell comprises a positive electrode, a negative electrode current collector spaced apart from the positive electrode, and an electrically insulating and ionically conductive solid electrolyte. The positive electrode has a major facing surface. The negative electrode current collector has a thickness defined between a front side and an opposite back side thereof and a width defined between a first end and an opposite second end thereof. The thickness and the width of the negative electrode current collector are substantially perpendicular to one another. The electrically insulating and ionically conductive solid electrolyte is sandwiched between the major facing surface of the positive electrode and the front side of the negative electrode current collector. The negative electrode current collector is of unitary one-piece construction and has a three-dimensional porous structure with a void volume defined by an interconnected network of open pores. The interconnected network of open pores is defined by walls having wall surfaces that extend between the front side and the back side and between the first end and the second end of the negative electrode current collector. During charging of the electrochemical cell, lithium metal is plated onto the wall surfaces that extend between the front side and the back side and between the first end and the second end of the negative electrode current collector.

During charging of the electrochemical cell, lithium metal may not be plated onto the front side of the negative electrode current collector.

The electrochemical cell may comprise a lithium metal negative electrode. The lithium metal negative electrode may comprise, by weight, greater than 97% lithium. The lithium metal negative electrode may be formed within the open pores of the negative electrode current collector by the electrochemical deposition of lithium metal within the open pores of the negative electrode current collector during charging of the electrochemical cell. The lithium metal may be deposited substantially entirely within the open pores of the negative electrode current collector.

The electrochemical cell may have an internal dimension defined between the major facing surface of the positive electrode and the front side of the negative electrode current collector. In such case, during cycling of the electrochemical cell, the internal dimension of the electrochemical cell may remain substantially constant.

The walls of the negative electrode current collector may be made of an electrochemically inactive electrically conductive material. The electrochemically inactive electrically conductive material may comprise a nickel-based material, an iron-based material, a titanium-based material, a copper-based material, a tin-based material, or a combination thereof.

The wall surfaces of the negative electrode current collector may be coated with a layer of an electrochemically inactive carbon-based material.

The wall surfaces of the negative electrode current collector may not be defined by a plurality of discrete particles.

The negative electrode current collector may not comprise an electrochemically active lithium intercalation host material. In addition, the negative electrode current collector may not comprise an electrochemically active conversion material that can electrochemically alloy with lithium or form compound phases with lithium.

The positive electrode may have a capacity, and the void volume of the negative electrode current collector may correspond to the capacity of the positive electrode.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a schematic side cross-sectional view of an anode-free electrochemical cell for a secondary lithium metal battery, wherein the electrochemical cell includes a positive electrode, a three-dimensional negative electrode current collector, and an ionically conductive electrolyte disposed between the positive electrode and the negative electrode current collector,

FIG. 2 is a schematic side cross-sectional view of the electrochemical cell of FIG. 1 after the electrochemical cell has been at least partially charged, wherein lithium metal is deposited in the form of a lithium metal negative electrode within an interconnected network of open pores defined by and within the three-dimensional negative electrode current collector.

FIG. 3 is a schematic perspective view of the three-dimensional negative electrode current collector of FIGS. 1 and 2.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent on a weight percentage (%) basis. This may include compositions or materials having, by weight, greater than 50% X, as well as those having, by weight, less than 50% X, so long as X is the single largest constituent of the composition or material.

Example embodiments will now be described more fully with reference to the accompanying drawings.

The present disclosure relates to electrochemical cells that cycle lithium ions and that may be described as “anode-free” because the electrochemical cells may be initially assembled with a bare negative electrode current collector and may be substantially free of negative electrode materials in the form of electrochemically active intercalation host materials and/or electrochemically active conversion materials. The electrochemical cells include negative electrode current collectors having a three-dimensional porous structure that defines an interconnected network of open pores. During initial and repeated charging of the electrochemical cells, lithium metal is deposited or plated within the open pores of the negative electrode current collectors, thereby forming a lithium metal negative electrode within the open pores of the negative electrode current collector. Because lithium metal is preferentially deposited within the open pores of the negative electrode current collectors (instead of being plated on planar facing surfaces thereof), volumetric changes experienced by the electrochemical cells during cycling thereof are effectively avoided or minimized. In addition, the three-dimensional porous structure of the negative electrode current collectors may help prevent or inhibit the formation of lithium dendrites and the loss of active lithium during cycling of the electrochemical cells.

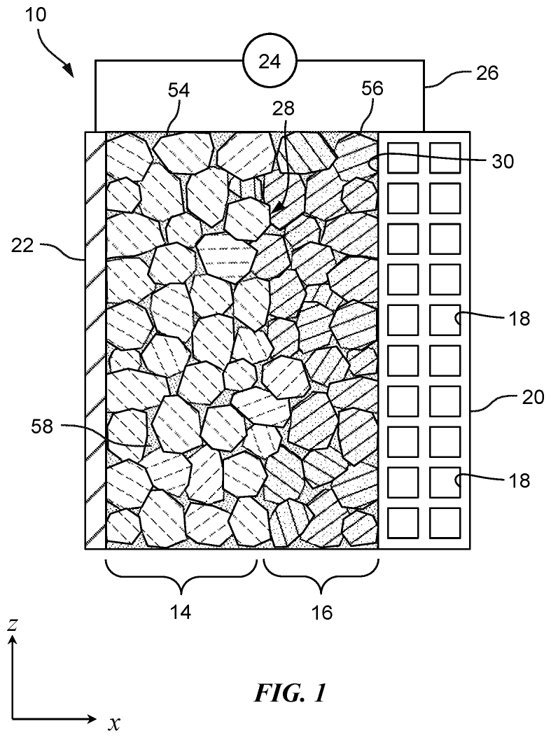

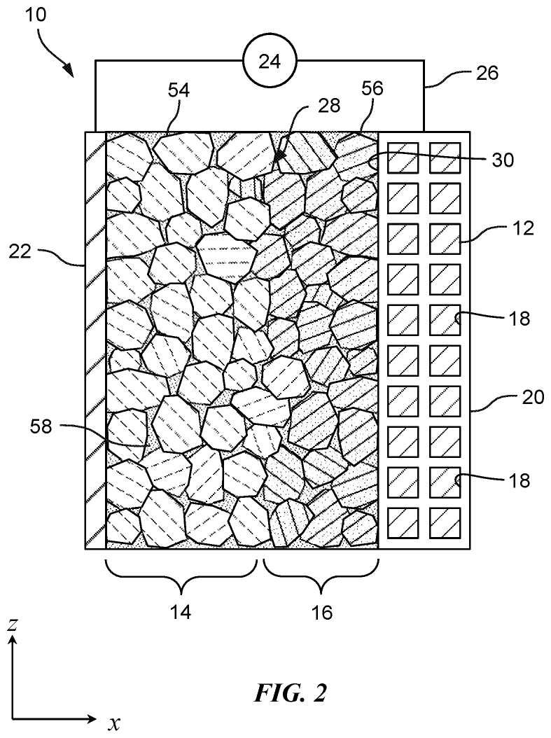

FIG. 1 depicts an anode-free electrochemical cell 10 that may be included in a battery that cycles lithium ions, such as a secondary lithium metal battery. The electrochemical cell 10 includes a positive electrode 14, a three-dimensional negative electrode current collector 20, and an ionically conductive electrolyte 16 disposed between the positive electrode 14 and the negative electrode current collector 20. The positive electrode 14 is disposed on a major surface of a positive electrode current collector 22. A facing surface 28 of the positive electrode 14 faces toward and opposes a facing surface 30 of the negative electrode current collector 20. An interconnected network of open pores 18 is defined within the negative electrode current collector 20. In practice, the negative and positive electrode current collectors 20, 22 may be electrically coupled to a load or an external power source 24 via an external circuit 26. Referring now to FIG. 2, during initial and repeated charging of the electrochemical cell 10, lithium metal is deposited in the form of a lithium metal negative electrode 12 within the interconnected network of open pores 18 defined by and within the three-dimensional negative electrode current collector 20.

The anode-free electrochemical cell 10 may be used in secondary lithium metal batteries for vehicle or automotive transportation applications (e.g., motorcycles, boats, tractors, buses, motorcycles, mobile homes, campers, and tanks), as well as in a wide variety of other industries and applications, including aerospace components, consumer products, devices, buildings (e.g., houses, offices, sheds, and warehouses), office equipment and furniture, and industrial equipment machinery, agricultural or farm equipment, or heavy machinery, by way of non-limiting example. In certain aspects, the electrochemical cell 10 may be used in secondary lithium-ion batteries for Hybrid Electric Vehicles (HEVs) and/or Electric Vehicles (EVs).

The lithium metal negative electrode 12 and the positive electrode 14 are formulated such that, when the electrochemical cell 10 is at least partially charged, an electrochemical potential difference is established between the lithium metal negative electrode 12 and the positive electrode 14. During discharge of the electrochemical cell 10, the electrochemical potential established between the lithium metal negative electrode 12 and the positive electrode 14 drives spontaneous redox reactions within the electrochemical cell 10 and the release of lithium ions and electrons at the negative electrode 12. The released lithium ions travel from the negative electrode 12 to the positive electrode 14 through the electrolyte 16, and the electrons travel from the negative electrode 12 to the positive electrode 14 via the external circuit 26, which generates an electric current. After the electrochemical cell 10 has been partially or fully discharged, the electrochemical cell 10 may be recharged by connecting the positive electrode 14 and the negative electrode current collector 20 to the external power source 24, which drives nonspontaneous redox reactions within the electrochemical cell 10 and the release of the lithium ions and the electrons from the positive electrode 14. The repeated charging and discharge of the electrochemical cell 10 may be referred to herein as “cycling,” with a full charge event followed by a full discharge event being considered a full cycle.

The lithium metal negative electrode 12 is disposed within the open pores 18 defined by and within the three-dimensional negative electrode current collector 20. The lithium metal negative electrode 12 comprises electrochemically active lithium metal and may comprise a lithium metal alloy or may consist essentially of lithium (Li) metal. For example, the lithium metal negative electrode 12 may comprise, by weight, greater than 97% lithium or, more preferably, greater than 99% lithium.

The lithium metal negative electrode 12 preferably does not comprise an electrochemically active negative electrode material, i.e., an element or compound that can undergo a reversible redox reaction with lithium during operation of the electrochemical cell 10. For example, the lithium metal negative electrode 12 preferably does not comprise an intercalation host material that is formulated to undergo the reversible insertion or intercalation of lithium ions. In addition, the lithium metal negative electrode 12 preferably does not comprise a conversion material that can electrochemically alloy with and form compound phases with lithium. Some examples of electrochemically active negative electrode materials that are preferably excluded from the lithium metal negative electrode 12 include carbon-based materials (e.g., graphite, activated carbon, carbon black, and graphene), silicon and silicon-based materials, tin oxide, aluminum, indium, zinc, cadmium, lead, germanium, tin, antimony, titanium oxide, lithium titanium oxide, lithium titanate, lithium oxide, metal oxides (e.g., iron oxide, cobalt oxide, manganese oxide, copper oxide, nickel oxide, chromium oxide, ruthenium oxide, and/or molybdenum oxide), metal phosphides, metal sulfides, and metal nitrides (e.g., phosphides, sulfides, and/or nitrides or iron, manganese, nickel, copper, and/or cobalt).

The positive electrode 14 may be in the form of a continuous porous layer of material deposited on the major surface of a positive electrode current collector 22. The positive electrode 14 may include particles 54 of one or more electrochemically active (electroactive) materials that can undergo a reversible redox reaction with lithium at a higher electrochemical potential than the electrochemically active material of the negative electrode 12 such that an electrochemical potential difference exists between the lithium metal negative electrode 12 and the positive electrode 14. For example, the positive electrode 14 may comprise a material that can undergo lithium intercalation and deintercalation or can undergo a conversion by reaction with lithium. In aspects, the positive electrode 14 may comprise an intercalation host material that can undergo the reversible insertion or intercalation of lithium ions. In such case, the intercalation host material of the positive electrode 14 may comprise a layered oxide represented by the formula LiMeO₂, an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In further aspects, the positive electrode 14 may comprise a conversion material including a component that can undergo a reversible electrochemical reaction with lithium, in which the component undergoes a phase change or a change in crystalline structure accompanied by a change in oxidation state. In such case, the conversion material of the positive electrode 14 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof. Examples of metals for inclusion in the conversion material of the positive electrode 14 include iron, manganese, nickel, copper, and cobalt. In aspects, the electrochemically active material of the positive electrode 14 may comprise LiCoO₂, LiMn₂O₄, LiNi_{0.5}Mn_{1.5}O₄, LiV₂(PO₄)₃, and/or LiMn_{0.7}Fe_{0.3}PO₄.

The electroactive material particles 54 of the positive electrode 14 may constitute, by weight, greater than or equal to about 30% to less than or equal to about 98% of the positive electrode 14. The electroactive material particles 54 of the positive electrode 14 may provide the positive electrode 14 with an areal capacity of greater than or equal to about 0.5 milliampere hours per square centimeter (mAh/cm²) to less than or equal to about 10 mAh/cm², or greater than or equal to about 0.5 mAh/cm² to less than or equal to about 5 mAh/cm². For example, the electroactive material particles 54 may provide the positive electrode layer 12 with an areal capacity of about 3 mAh/cm².

The positive electrode 14 may have a thickness, defined between the major surface of the positive electrode current collector 22 and the ionically conductive electrolyte 16 of greater than or equal to about 10 micrometers to less than or equal to about 400 micrometers.

The electroactive material particles 54 of the positive electrode 14 may be intermingled with a polymer binder to provide the positive electrode 14 with structural integrity. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than 0% to less than or equal to about 20% of the positive electrode 14.

The positive electrode 14 optionally may include particles of an electrochemically inactive electrically conductive material. Examples of electrically conductive materials include particles of a carbon-based material, metal particles, and/or an electrically conductive polymer. Examples of electrically conductive carbon-based materials include carbon black (e.g., acetylene black), graphite, graphene (e.g., graphene nanoplatelets), carbon nanotubes (e.g., single-walled carbon nanotubes), and/or carbon fibers (e.g., carbon nanofibers). Examples of electrically conductive metal particles include powdered copper, nickel, aluminum, silver, and/or alloys thereof. Examples of electrically conductive polymers include polyaniline, polythiophene, polyacetylene, and/or polypyrrole. The electrochemically inactive electrically conductive material particles of the positive electrode 14 may constitute, by weight, greater than or equal to 0% to less than or equal to about 30% of the positive electrode 14.

The ionically conductive electrolyte 16 provides a medium for the conduction of lithium ions through the electrochemical cell 10 between the lithium metal negative electrode 12 and the positive electrode 14 and may be in the form of a liquid, solid, gel, or a combination thereof. The electrolyte 16 may have a thickness of greater than or equal to about 5 micrometers to less than or equal to about 50 micrometers and a porosity in a range of from about 5% to about 50%.

In aspects, the electrolyte 16 may comprise particles 56 of an electrically insulating and ionically conductive inorganic solid electrolyte material, e.g., a metal oxide-based material, a sulfide-based material, a nitride-based material, a hydride-based material, a halide-based material, and/or a borate-based material. Examples of metal oxide-based solid electrolyte materials include NASICON-type solid electrolyte materials (e.g., Li_{1.4}Al_{0.4}Ti_{1.6}(PO₄)₃), LISICON-type solid electrolyte materials (e.g., Li₂₊₂ₓZn₁₋ₓ GeO₄), perovskite-type solid electrolyte materials (e.g., Li₃ₓLa_{2/3-x}TiO₃), garnet-type solid electrolyte materials (e.g., Li₇La₃Zr₂O₁₂), and/or metal-doped or aliovalent-substituted metal oxide-based solid electrolyte materials (e.g., Al- or Nb-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, and/or Al-substituted perovskite, Li_{1+x+y}AlₓTi₂₋ₓSi_{y}P_{3-y}O₁₂). Examples of sulfide-based solid electrolyte materials include: argyrodite materials represented by the formula Li₆PS₅X, where X=Cl, Br, I; lithium phosphorus sulfide materials represented by one or more of the following formulas Li₃PS₄, Li_{9.6}P₃S₁₂, and/or Li₇P₃S₁₁; LGPS-type materials represented by the formula Li₁₁₋ₓM₂₋ₓP₁₊ₓS₁₂, where M=Ge, Sn, Si (e.g., Li₁₀GeP₂S₁₂, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, and/or Li₁₀(Si_{0.5}Sn_{0.5})P₂S₁₂); Li₂S—P₂S₅-type materials; Li₂S—P₂S₅-MOₓ-type materials; Li₂S—P₂S₅-MSₓ-type materials; thio-LISICON-type materials (e.g., Li_{3.25}Ge_{0.25}P_{0.75}S₄); Li_{3.4}Si_{0.4}P_{0.6}S₄; Li₁₀GeP₂S_{11.7}O_{0.3}; Li_{9.54}Si_{1.74}P_{1.44}S_{11.7}Cl_{0.3}; Li_{3.833}Sn_{0.833}As_{0.166}S₄; LiI—Li₄SnS₄; and/or Li₄SnS₄. Examples of nitride-based solid electrolyte materials include: Li₃N, Li₇PN₄, and/or LiSi₂N₃. Examples of hydride-based solid electrolyte materials include: LiBH₄, LiBH₄—LiX, where X=Cl, Br or I, LiNH₂, Li₂NH, LiBH₄—LiNH₂, and/or Li₃AlH₆. Examples of halide-based solid electrolyte materials include: LiI, Li₃InCl₆, Li₂CdCl₄, Li₂MgCl₄, Li₂CdI₄, Li₂ZnI₄, and/or Li₃OCl. Examples of borate-based solid electrolyte materials include: Li₂B₄O₇ and/or Li₂O—B₂O₃—P₂O₅. The solid electrolyte material particles 56 may have a D50 diameter of greater than or equal to about 0.01 micrometers to less than or equal to about 50 micrometers. The solid electrolyte material particles 56 may constitute, by weight, greater than or equal to about 30% to less than or equal to about 98% of the electrolyte 16.

The electrolyte 16 extends between and may be in direct physical contact with the facing surface 28 of the positive electrode 14 and with the facing surface 30 of the negative electrode current collector 20. In aspects, the composition of the electrolyte 16 may be substantially the same across the entire thickness thereof the electrolyte 16, i.e., between the positive electrode 14 and the negative electrode current collector 20, and throughout the entire volume of the electrolyte 16. Alternatively, in some aspects, a first region of the electrolyte 16 may exhibit a different composition than a second region of the electrolyte 16. For example, a first region of the electrolyte 16 may be disposed along and optionally in direct physical contact with the facing surface 28 of the positive electrode 14 and a second region of the electrolyte 16 may be disposed along and optionally in direct physical contact with the facing surface 30 of the negative electrode current collector 20, and the composition of the first region may be different than the composition of the second region. In some aspects, the solid electrolyte material particles 56 in the first region of the electrolyte 16 may have a different composition than the solid electrolyte material particles 56 in the second region of the electrolyte 16.

In aspects, some of the solid electrolyte material particles 56 may be intermingled with the electroactive material particles 54 of the positive electrode 14. In such case, the solid electrolyte material particles 56 may constitute, by weight, greater than 0% to less than or equal to about 50% of the positive electrode 14.

In aspects, the electrolyte 16 optionally may comprise a gel polymer electrolyte 58 that infiltrates the pores of the positive electrode 14 and the pores defined between the solid electrolyte material particles 56. The gel polymer electrolyte 58 may be in direct physical contact with and wet the facing surface 30 of the negative electrode current collector 20. In aspects, each of the electroactive material particles 54 of the positive electrode 14 and/or each of the solid electrolyte material particles 56 may be at least partially encased in the gel polymer electrolyte 58 such that the gel polymer electrolyte 58 wets an exterior surface of each of the electroactive material particles 54 and/or each of the solid electrolyte material particles 56. The gel polymer electrolyte 58 may comprise a polymer matrix and a liquid electrolyte. The polymer matrix may act as a host for the liquid electrolyte and may provide the gel polymer electrolyte 58 with structural integrity. The polymer matrix may constitute, by weight, greater than or equal to about 0.1% to less than or equal to about 50% of the gel polymer electrolyte 58 and the liquid electrolyte may constitute, by weight, greater than or equal to about 5% to less than or equal to about 90% of the gel polymer electrolyte 58.

The polymer matrix of the gel polymer electrolyte 58 may comprise poly(ethylene oxide) (PEO), poly(acrylic acid) (PAA), poly(methyl methacrylate) (PMMA), carboxymethyl cellulose (CMC), polyacrylonitrile (PAN), polyvinylidene difluoride (PVDF), poly(vinyl alcohol) (PVA), polyvinylpyrrolidone (PVP), a copolymer of poly(vinylidene fluoride) and hexafluoropropylene, also referred to as poly(vinylidene fluoride-co-hexafluoropropylene) (PVDF-HFP), or a combination thereof. The liquid electrolyte of the gel polymer electrolyte 58 may comprise a nonaqueous aprotic organic solvent and a lithium salt dissolved in the organic solvent. Examples of nonaqueous aprotic organic solvents include alkyl carbonates, for example, cyclic carbonates (e.g., ethylene carbonate (EC), propylene carbonate (PC), butylene carbonate (BC), fluoroethylene carbonate (FEC), vinylene carbonate(VC), glycerol carbonate (GC), and/or 1,2-Butylene carbonate) and/or linear carbonates (e.g., dimethyl carbonate (DMC), diethyl carbonate (DEC), and/or ethylmethylcarbonate (EMC)); aliphatic carboxylic esters (e.g., methyl formate, methyl acetate, and/or methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. Examples of lithium salts include lithium bis(oxalato)borate, LiB(C2O4)2 (LiBOB); lithium tetracyanoborate, Li(B(CN4) (LiTCB); lithium tetrafluoroborate, LiBF4; lithium bis(monofluoromalonato)borate (LiBFMB); lithium trifluoromethanesulfonate, LiCF3SO3); lithium bis(fluorosulfonyl)imide, LiN(FSO2)2 (LiSFI); lithium cyclo-difluoromethane-1,1-bis(sulfonyl)imide (LiDMSI); lithium bis(trifluoromethane)sulfonylimide, LiN(CF3SO2)2; lithium bis(perfluoroethanesulfonyl)imide, LiN(C2F5SO2)2; lithium cyclo-hexafluoropropane-1,1-bis(sulfonyl)imide (LiHPSI); lithium difluoro(oxalato)borate (LiDFOB); lithium bis(trifluoromethanesulfonyl)imide (LiTFSI); and combinations thereof.

The negative electrode current collector 20 is of unitary one-piece construction and has a three-dimensional porous structure that defines an interconnected network of open pores 18. During charging of the electrochemical cell 10, lithium metal is deposited within the open pores 18 of the negative electrode current collector 20, instead of being deposited on the facing surface 30 thereof. In practice, the three-dimensional porous structure of the negative electrode current collector 20 helps prevent or inhibit the formation of lithium dendrites on the facing surface 30 of the negative electrode current collector 20 and minimizes or eliminates volumetric changes within the electrochemical cell 10 during cycling thereof.

The three-dimensional porous structure of the negative electrode current collector 20 may be a macroporous structure, with open pores 18 having pore diameters of greater than 50 nanometers. For example, the negative electrode current collector 20 may exhibit a macroporous structure with open pores 18 having pore diameters of greater than or equal to about 2 micrometers to less than or equal to about 1000 micrometers. The three-dimensional porous structure of the negative electrode current collector 20 may provide the negative electrode current collector 20 with a porosity or void volume fraction of greater than or equal to about 0.5 to less than or equal to about 0.99.

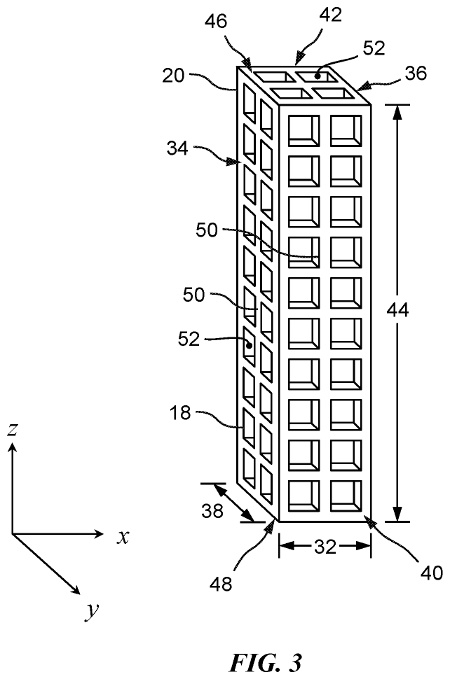

As best shown in FIG. 3, the negative electrode current collector 20 may have a thickness 32 defined between a front side 34 and an opposite back side 36 thereof, a width 38 defined between a first end 40 and an opposite second end 42 thereof, and a height 44 defined between a top end 46 and an opposite bottom end 48 thereof. In the context of the x-y-z coordinate system depicted in FIG. 3, the thickness 32 of the negative electrode current collector 20 is measured along the “x” axis, the width 38 of the negative electrode current collector 20 is measured along the “y” axis, and the height 44 of the negative electrode current collector 20 is measured along the “z” axis, wherein the x, y, and z axes are perpendicular to one another.

The interconnected network of open pores 18 in the negative electrode current collector 20 may be defined by walls 50 having wall surfaces 52 that extend at least partway between the front side 34 and the back side 36, between the first end 40 and the second end 42, and/or between the top end 46 and the bottom end 48 of the negative electrode current collector 20. The morphology of the walls 50 of the negative electrode current collector 20 may be varied, straight, branched, or dendritic. The morphology of the wall surfaces 52 may be smooth or rough-walled. The wall surfaces 52 of the negative electrode current collector 20 are not defined by a plurality of discrete particles, such as in a packed-bed.

In aspects, the walls 50 of the negative electrode current collector 20 may define a three-dimensional stochastic or periodic contiguous lattice support structure or truss including a plurality of repeating unit cells (e.g., a tessellation of one or more geometric shapes). In FIGS. 1, 2, and 3, the walls 50 of the negative electrode current collector 20 define a plurality of regularly spaced-apart open pores 18, with each of the pores 18 exhibiting a square cross-sectional shape. In other aspects, the cross-sectional shape of the open pores 18 may be circular, elliptical, or another polygonal shape, e.g., triangular, rectangular, hexagonal, quadrilateral, octagonal, or a combination thereof. In aspects, the porous structure of negative electrode current collector 20 may be reticulated. For example, the porous structure of negative electrode current collector 20 may be defined by a reticulated open-celled foam. In aspects, the cross-sectional area of each open pore 18 may be greater than or equal to about 0.1 μm² to less than or equal to about 1000 μm².

In aspects where the porous structure of negative electrode current collector 20 is defined by a periodic lattice support structure or truss including a plurality of repeating unit cells, the thickness 32 of the negative electrode current collector 20 may be greater than or equal to about 1 micrometer to less than or equal to about 50 micrometers. In aspects where the porous structure of negative electrode current collector 20 is defined by a stochastic support structure (e.g., a reticulated foam), the thickness 32 of the negative electrode current collector 20 may be greater than or equal to about 10 micrometers to less than or equal to about 4 millimeters.

The walls 50 of the negative electrode current collector 20 may be made of an electrochemically inactive electrically conductive material. Examples of electrochemically inactive electrically conductive materials include nickel-based materials (e.g., nickel and chromium or tin-containing alloys), iron-based materials (e.g., stainless steel), titanium-based materials, copper-based materials, tin-based materials, and combinations thereof. In aspects, the electrochemically inactive electrically conductive material of the walls 50 of the negative electrode current collector 20 may comprise a three-dimensional carbon nanofiber foam, a graphene foam, a carbon cloth, carbon fiber-embedded carbon nanotubes, carbon nanotube paper, a graphene and nickel composite foam, or a combination thereof. In aspects where the walls 50 of the negative electrode current collector 20 are made of metal, the wall surfaces 52 of the walls 50 of the negative electrode current collector 20 may be coated with an electrochemically inactive carbon-based material, e.g., graphene, for corrosion prevention or inhibition.

During charging of the electrochemical cell 10, the lithium metal negative electrode 12 is formed within the open pores 18 of the negative electrode current collector 20 by the electrochemical deposition or plating of lithium metal on the wall surfaces 52 within the open pores 18 of the negative electrode current collector 20. The lithium metal may be deposited or plated directly or indirectly on the wall surfaces 52 of the negative electrode current collector 20. During discharge of the electrochemical cell 10, lithium ions are released from the open pores 18 of the negative electrode current collector 20 and stored in the positive electrode 14. During charging and discharge of the electrochemical cell 10, the volume of the negative electrode 12 in the open pores 18 of the negative electrode current collector 20 varies while the volume of the negative electrode current collector 20 remains constant. As such, the volumetric changes experienced by the negative electrode 12 during charging and discharge of the electrochemical cell 10 do not result in a corresponding change in the overall volume of the electrochemical cell 10. Instead, the volume of the electrochemical cell 10 remains substantially constant during cycling. Therefore, the three-dimensional porous structure of the negative electrode current collector 20 effectively overcomes the volumetric changes oftentimes experienced by secondary lithium metal batteries due to the repeated expansion and contraction of their negative electrodes during charging and discharge thereof. In addition, the three-dimensional porous structure of the negative electrode current collector 20 promotes the deposition or plating of lithium metal within the open pores 18 of the negative electrode current collector 20, instead of on the facing surface 30 or the front side 34 of the negative electrode current collector 20. In turn, the three-dimensional porous structure of the negative electrode current collector 20 helps prevent or inhibit the formation of lithium dendrites on the facing surface 30 or the front side 34 of the negative electrode current collector 20 and may help improve the coulombic efficiency of the electrochemical cell 10, for example, by preventing the loss of active lithium during cycling of the electrochemical cell 10.

The maximum amount of energy that can be extracted from the electrochemical cell 10 under certain conditions is referred to as the capacity of the electrochemical cell 10 and is typically measured in ampere-hours (Ahr), which is defined as the number of hours for which the electrochemical cell 10 can provide a current equal to the discharge rate at the nominal voltage of the electrochemical cell 10. The capacity of the electrochemical cell 10 may be limited by the capacity of the positive electrode 14. The capacity of the positive electrode 14 may be calculated based upon the mass (or volume) and the gravimetric (or volumetric) specific capacity of the electrochemically active material in the positive electrode 14. In practice, it may be desirable for capacity of the positive electrode 14 to match or be substantially equal to the capacity of the negative electrode 12. In some situations, it may be desirable for the capacity of the positive electrode 14 to be less than the capacity of the negative electrode 12, or vice versa. The ratio of the capacity of the positive electrode 14 to the capacity of the negative electrode 12 may be referred to as the positive-to-negative capacity ratio (or P/N ratio). In aspects, the P/N ratio may be greater than or equal to about 0.9 to less than or equal to about 1.1. In aspects, the P/N ratio may be about one (1).

The negative electrode current collector 20 may have a void volume defined by the interconnected network of open pores 18. In aspects, the void volume of the negative electrode current collector 20 may be tailored so that, when the electrochemical cell 10 is fully charged, the capacity of the negative electrode 12 is substantially equal to the capacity of the positive electrode 14. For example, in aspects where the positive electrode 14 has a capacity of 100 ampere-hours (Ahr), the void volume of the negative electrode current collector 20 may be substantially equal to the capacity of the positive electrode 14 (100 Ahr) divided by the volumetric capacity of lithium metal (i.e., about 2.061 Ah/cm³). In such case, the void volume of the negative electrode current collector 20 may be about 48.5 cubic centimeters (cm³).

The positive electrode current collector 22 is electrically conductive and provides an electrical connection between the external circuit 26 and the positive electrode 14. In aspects, the positive electrode current collector 22 may be in the form of nonporous metal foils, perforated metal foils, porous metal meshes, or a combination thereof. The positive electrode current collector 22 may be made of aluminum (Al) or another appropriate electrically conductive material.

The foregoing description of the embodiments has been provided for purposes of illustration and description. It is not intended to be exhaustive or to limit the disclosure. Individual elements or features of a particular embodiment are generally not limited to that embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions, the electrochemical cell comprising:
a positive electrode;
a negative electrode current collector spaced apart from the positive electrode; and
an ionically conductive electrolyte disposed between the positive electrode and the negative electrode current collector,
wherein the negative electrode current collector is of unitary one-piece construction and has a three-dimensional porous structure that defines an interconnected network of open pores, and
wherein, during charging of the electrochemical cell, lithium metal is deposited within the open pores of the negative electrode current collector.

2. The electrochemical cell of claim 1, wherein the negative electrode current collector has a thickness defined between a front side and an opposite back side thereof and a width defined between a first end and an opposite second end thereof, wherein the thickness and the width of the negative electrode current collector are substantially perpendicular to one another, and wherein the interconnected network of open pores is defined by walls having wall surfaces that extend between the front side and the back side and between the first end and the second end of the negative electrode current collector.

3. The electrochemical cell of claim 2, wherein, during charging of the electrochemical cell, lithium metal is plated onto the walls surfaces that extend between the front side and the back side and between the first end and the second end of the negative electrode current collector.

4. The electrochemical cell of claim 2, wherein the thickness of the negative electrode current collector is greater than or equal to about 1 micrometer to less than or equal to about 4 millimeters.

5. The electrochemical cell of claim 2, wherein the walls of the negative electrode current collector are made of an electrochemically inactive electrically conductive material, wherein the electrochemically inactive electrically conductive material comprises a nickel-based material, an iron-based material, a titanium-based material, a copper-based material, a tin-based material, or a combination thereof.

6. The electrochemical cell of claim 5, wherein the wall surfaces of the walls of the negative electrode current collector are coated with a layer of an electrochemically inactive carbon-based material.

7. The electrochemical cell of claim 1, wherein the negative electrode current collector has a porosity of greater than or equal to about 0.5 to less than or equal to about 0.99.

8. The electrochemical cell of claim 1, further comprising:
a lithium metal negative electrode that comprises, by weight, greater than 97% lithium, wherein the lithium metal negative electrode is formed within the open pores of the negative electrode current collector by the electrochemical deposition of lithium metal within the open pores of the negative electrode current collector during charging of the electrochemical cell, and wherein the lithium metal is deposited substantially entirely within the open pores of the negative electrode current collector.

9. The electrochemical cell of claim 1, wherein the interconnected network of open pores is defined by a three-dimensional stochastic support structure.

10. The electrochemical cell of claim 1, wherein the interconnected network of open pores is defined by a three-dimensional periodic lattice support structure including a plurality of repeating unit cells.

11. The electrochemical cell of claim 1, wherein the ionically conductive electrolyte comprises solid electrolyte material particles, and wherein the solid electrolyte material particles comprise a metal oxide-based material, a sulfide-based material, a nitride-based material, a hydride-based material, a halide-based material, a borate-based material, or a combination thereof.

12. An electrochemical cell that cycles lithium ions, the electrochemical cell comprising:
a positive electrode having a major facing surface;
a negative electrode current collector spaced apart from the positive electrode, the negative electrode current collector having a thickness defined between a front side and an opposite back side thereof and a width defined between a first end and an opposite second end thereof, the thickness and the width of the negative electrode current collector being substantially perpendicular to one another; and
an electrically insulating and ionically conductive solid electrolyte sandwiched between the major facing surface of the positive electrode and the front side of the negative electrode current collector,
wherein the negative electrode current collector is of unitary one-piece construction and has a three-dimensional porous structure with a void volume defined by an interconnected network of open pores,
wherein the interconnected network of open pores is defined by walls having wall surfaces that extend between the front side and the back side and between the first end and the second end of the negative electrode current collector, and
wherein, during charging of the electrochemical cell, lithium metal is plated onto the wall surfaces that extend between the front side and the back side and between the first end and the second end of the negative electrode current collector.

13. The electrochemical cell of claim 12, wherein, during charging of the electrochemical cell, lithium metal is not plated onto the front side of the negative electrode current collector.

14. The electrochemical cell of claim 12, further comprising:
a lithium metal negative electrode that comprises, by weight, greater than 97% lithium, wherein the lithium metal negative electrode is formed within the open pores of the negative electrode current collector by the electrochemical deposition of lithium metal within the open pores of the negative electrode current collector during charging of the electrochemical cell, and wherein the lithium metal is deposited substantially entirely within the open pores of the negative electrode current collector.

15. The electrochemical cell of claim 14, wherein, the electrochemical cell has an internal dimension defined between the major facing surface of the positive electrode and the front side of the negative electrode current collector, and wherein during cycling of the electrochemical cell, the internal dimension of the electrochemical cell remains substantially constant.

16. The electrochemical cell of claim 12, wherein the walls of the negative electrode current collector are made of an electrochemically inactive electrically conductive material, wherein the electrochemically inactive electrically conductive material comprises a nickel-based material, an iron-based material, a titanium-based material, a copper-based material, a tin-based material, or a combination thereof.

17. The electrochemical cell of claim 16, wherein the wall surfaces of the negative electrode current collector are coated with a layer of an electrochemically inactive carbon-based material.

18. The electrochemical cell of claim 12, wherein the wall surfaces of the negative electrode current collector are not defined by a plurality of discrete particles.

19. The electrochemical cell of claim 12, wherein the negative electrode current collector does not comprise an electrochemically active lithium intercalation host material, and wherein the negative electrode current collector does not comprise an electrochemically active conversion material that can electrochemically alloy with lithium or form compound phases with lithium.

20. The electrochemical cell of claim 12, wherein the positive electrode has a capacity, and wherein the void volume of the negative electrode current collector corresponds to the capacity of the positive electrode.
